(19) United States
(12) Patent Application Publication
(10) Pub. No.: US 2019/0031187 A1
(43) Pub. Date: Jan. 31, 2019

(54) SYSTEMS AND METHODS FOR DETERMINING DRIVE MODES

(71) Applicant: Faraday&Future Inc., Gardena, CA (US)

(72) Inventors: Juan M. Noguerol, Gardena, CA (US); Misia K. Clive Groszek, Los Angeles, CA (US); Chris Wang, Los Angeles, CA (US); Julie Ann Santiano, Los Angeles, CA (US); Nicholas William Dazé, Los Angeles, CA (US)

(21) Appl. No.: 15/711,861

(22) Filed: Sep. 21, 2017

Related U.S. Application Data
(60) Provisional application No. 62/398,358, filed on Sep. 22, 2016.

(51) Int. Cl. B60W 30/02; B60W 10/22; B60W 10/02; B60W 10/18; B60W 40/08; H04L 29/08

(52) U.S. Cl. CPC B60W 30/025; B60W 10/22; B60W 10/02; B60W 10/18; B60W 2710/20; H04L 67/1097; B60W 2040/0881; B60W 2710/18; B60W 40/08

(57) ABSTRACT

A system for determining a drive mode for a vehicle is disclosed. The system may include one or more processors connected to a cloud network. The one or more processors may be configured to detect one or more occupants of the vehicle, and receive, from the cloud network, user profiles including one or more user preferences associated with the detected one or more occupants. The one or more processors may be further configured to determine the drive mode, including a plurality of vehicle feature settings, based on the user preferences weighted according to a weighting rule. The system may also include a storage device configured to store the plurality of vehicle feature settings.

### CROSS-REFERENCE TO RELATED APPLICATIONS

This application claims the benefit of U.S. Provisional Application No. 62/398,358, filed Sep. 22, 2016, the entirety of which is hereby incorporated by reference.

### TECHNICAL FIELD

The present disclosure generally relates to systems and methods for determining a drive mode for a vehicle, and more specifically, to determining the drive mode based on occupants' preferences, and providing a user-adjustable graphic user interface (GUI) to the occupants and determining the drive mode based on the user input on the GUI.

### BACKGROUND

A vehicle user may wish to customize a drive mode, including a collection of features of a vehicle, such as the interior climate, entertainment, and suspension settings. Although a vehicle user may be able to configure each of these features manually, manual selection of features and/or settings may be burdensome. Moreover, different users may operate a vehicle according to different feature preferences, requiring frequent and manual recalibration of vehicle features according to user preference. This is inefficient and time consuming.

Furthermore, some settings may only be controlled by a driver that may not share similar user preferences with passengers riding in the vehicle. For example, suspension settings may be controlled by the driver, but riding passengers may unanimously desire suspension settings different from the driver's preferences. Accordingly, existing customization of vehicle feature settings may not account for the preferences of all riding vehicle occupants.

Therefore, there exists a need to intelligently and efficiently determine and control features according to multiple user preferences. Moreover, vehicles are becoming more equipped with features, and automated driving is enabling occupants to conduct business and socialize. Therefore, there exists a need for improved systems and methods to collect preferences of vehicle occupants and determine drive modes according to such preferences.

### SUMMARY

One aspect of the present disclosure is directed to a system for determining a drive mode for a vehicle. The system may be performed by one or more processors connected to a cloud network. The one or more processors may detect one or more occupants of the vehicle, receive, from the cloud network, user profiles including one or more user preferences associated with the detected one or more occupants, and determine the drive mode, including a plurality of vehicle feature settings, based on the user preferences weighted according to a weighting rule. The system may also include a storage device configured to store the plurality of vehicle feature settings.

Another aspect of the present disclosure is directed to a method for determining a drive mode for a vehicle. The method may include detecting one or more occupants of the vehicle, receiving, from a cloud network, user profiles including one or more user preferences associated with the detected one or more occupants, determining the drive mode, including a plurality of vehicle feature settings, based on the user preferences weighted according to a weighting rule, and storing the plurality of vehicle feature settings.

Yet another aspect of the present disclosure is directed to a non-transitory computer-readable medium for determining a drive mode for a vehicle. The non-transitory computer-readable medium may store instructions executable by one or more processors connected to a cloud network to perform a method. The method may include detecting one or more occupants of the vehicle, receiving, from a cloud network, user profiles including one or more user preferences associated with the detected one or more occupants, determining the drive mode, including a plurality of vehicle feature settings, based on the user preferences weighted according to a weighting rule, and storing the plurality of vehicle feature settings.

A further aspect of the present disclosure is directed to a system for determining a drive mode for a vehicle. The system may be performed by a graphic user interface (GUI) and one or more processors. The GUI may provide a plurality of user-adjustable vehicle feature settings to a user, and detect a user interaction modifying the user-adjustable vehicle feature settings. The one or more processors may determine customized vehicle feature settings based on the user interaction, and determine a drive mode based on the customized vehicle feature settings.

Another aspect of the present disclosure is directed to a method for determining a drive mode for a vehicle. The method may include providing, on a GUI, a plurality of user-adjustable vehicle feature settings to a user, detecting, from the GUI, a user interaction modifying the user-adjustable vehicle feature settings, determining, by the one or more processors, customized vehicle feature settings based on the user interaction, and determining, by the one or more processors, a drive mode based on the customized vehicle feature settings.

Yet another aspect of the present disclosure is directed to a non-transitory computer-readable medium for determining a drive mode for a vehicle. The non-transitory computer-readable medium may store instructions executable by one or more processors connected to a graphic user interface (GUI) to perform a method. The method may include providing, on the GUI, a plurality of user-adjustable vehicle feature settings to a user, detecting a user interaction modifying the user-adjustable vehicle feature settings, determining customized vehicle feature settings based on the user interaction, and determining a drive mode based on the customized vehicle feature settings.

### BRIEF DESCRIPTION OF THE DRAWINGS

FIG. 1 is a schematic block diagram illustrating an exemplary system for determining a drive mode for a vehicle, in accordance with the disclosed embodiments;

FIG. 2 is a schematic block diagram illustrating an exemplary network server, used in the exemplary system of FIG. 1;

FIG. 3 is a schematic block diagram illustrating an exemplary vehicle controller, used in the exemplary system of FIG. 1;

FIG. 4 is a diagrammatic illustration of multiple exemplary graphical user interfaces used to configure drive modes;

FIG. 5 is a diagrammatic illustration of an exemplary graphical user interface used to configure vehicle exterior settings;

FIG. 6 is a diagrammatic illustration of an exemplary graphical user interface used to configure vehicle interior settings;

FIG. 7 is a diagrammatic illustration of an exemplary graphical user interface used to configure vehicle drive settings;

FIG. 8 is a diagrammatic illustration of an exemplary graphical user interface used to configure a sport mode;

FIG. 9 is a diagrammatic illustration of an exemplary graphical user interface used to configure an autonomous drive mode;

FIG. 10 is a flow chart illustrating an exemplary process performed by the exemplary system in FIG. 1, in accordance with the disclosed embodiments; and

FIG. 11 is a flow chart illustrating another exemplary process performed by the exemplary system in FIG. 1, in accordance with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

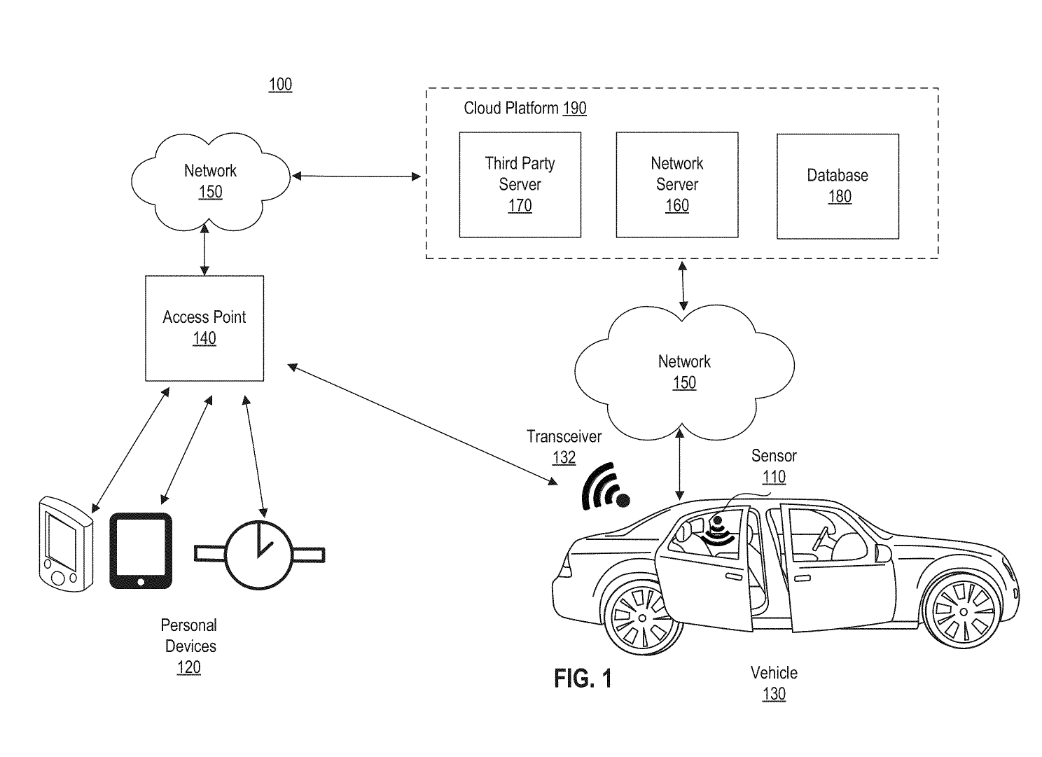

FIG. 1 is a schematic block diagram illustrating an exemplary embodiment for determining a drive mode for a vehicle, in accordance with the disclosed embodiments. As illustrated in FIG. 1, system 100 may include one or more personal devices 120, vehicle 130, and network 150.

Personal devices 120 may include personal computing devices such as, for example, desktop computers, notebook computers, mobile devices, tablets, smartphones, wearable devices such as smart watch, smart bracelet, and Google Glass″, and any other personal devices. Personal devices 120 may communicate with other parts of system 100 through network 150. Personal devices 120 may also include software and executable programs configured to communicate with network 150 and customize drive modes for one or more occupants riding in a vehicle 130. Other software and executable programs are contemplated.

Vehicle 130 may have any body style, such as a sports car, a coupe, a sedan, a pick-up truck, a station wagon, a sports utility vehicle (SUV), a minivan, or a conversion van. Vehicle 130 may be an electric vehicle, a fuel cell vehicle, a hybrid vehicle, or a conventional internal combustion engine vehicle. Vehicle 130 may also include software and executable programs configured to customize drive modes for one or more occupants riding in a vehicle 130. Vehicle 130 may be configured to be operated by a driver occupying vehicle 130, remotely controlled by a vehicle owner operating an application executed on a personal device 120, and/or autonomously controlled via advanced driver assistance systems (ADAS) and network server 150. Vehicle 130 may include one or more sensors 110 for detecting vehicle occupants and/or operators of vehicle 130. Sensors 110 may include cameras or other imaging device for identifying one or more passengers, drivers, and/or registered users affiliated with vehicle 130. Sensors 110 may also include GPS, LiDAR, or other positioning or proximity sensors for detecting personal devices 120 inside or near vehicle 130. Vehicle 130 may also include a transceiver 132 for communicating with access point 140 and network 150.

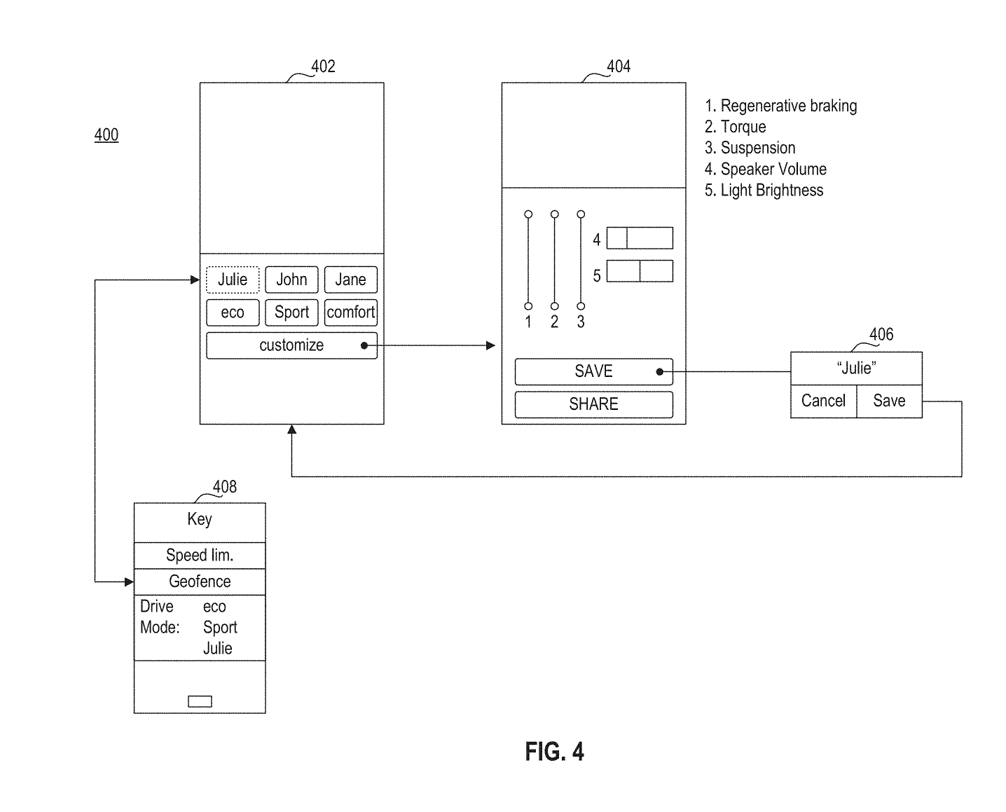

System 100 may allow for one or more personal devices 120 and/or vehicle 130 to transfer user profiles and customized drive modes associated with a drive mode application (e.g., illustrated in FIGS. 4-9) over network 150 to cloud platform 190 and/or vehicle 130. System 100 may include mobile or stationary (not shown) personal devices 120 located in residential premises and non-residential premises configured to communicate with network 150. Personal devices 120 and/or vehicle 130 may connect to network 150 by Wi-Fi or wireless access points (WAP). Bluetooth® or similar wireless technology may be contemplated. Network 150 may include a wireless network, such as a cellular network, a satellite network, the Internet, or a combination of these (or other) networks that are used to transport data. Furthermore, network 150 may be a wired network, such as an Ethernet network. Network 150 may transmit, for example, authentication services that enable personal devices 120 and/or vehicle 130 to access information, and drive mode instructions according to user data, vehicle data, drive mode information, and associated metadata.

In the exemplary system 100, personal devices 120 and vehicle 130 may communicate with one or more servers in cloud platform 190 through network 150. Cloud platform 190 may comprise one or more network servers 160, third party servers 170, and/or databases 180. Servers 160 and 170 may provide cloud services for users and their personal devices 120 and/or vehicle 130. For example, a cloud-based architecture may be implemented comprising a distributed portion that executes at another location in network 150 and a corresponding cloud portion that executes on a network server 160 in cloud platform 190. Servers in cloud platform 190 may also communicate with transceiver 132 of vehicle 130 over network 150 using appropriate cloud-based communication protocols, such as SOAP or REST and/or other protocols that would be known to those skilled in the art. Such communication may allow for remote control of drive mode operations of vehicle 130 by, for example, detecting vehicle occupants and identifying user profiles and drive mode preferences associated with the detected vehicle occupants. Such communication may also allow for remote control of drive mode operations of vehicle 130 by, for example, a user operating a GUI on a drive mode application executed on a personal device 120 and/or on vehicle 130 to configure drive mode settings.

As shown in FIG. 1, network 150 may be accessible to network servers 160, third party servers 170, and databases 180 in cloud platform 190, for sending and receiving information, such as user data, vehicle data, and drive mode information, within system 100. Network server 160, third party server 170, and database 180 may include network, cloud, and/or backup services. For example, in some embodiments, network server 160 may include a cloud computing service such as Microsoft Azure™ or Amazon Web Services™. Additional cloud-based wireless access solutions compatible with LTE (e.g., using the 3.5 GHz spectrum in the US) are contemplated. In some embodiments, third party server 170 may include a messaging or notification service, for example, that may notify or alert a user of at least one drive mode update to vehicle 130 through the cloud network. A selected drive mode may include at least one of a business mode, sport mode, social mode, nature mode, or rest mode, but other drive modes are contemplated.

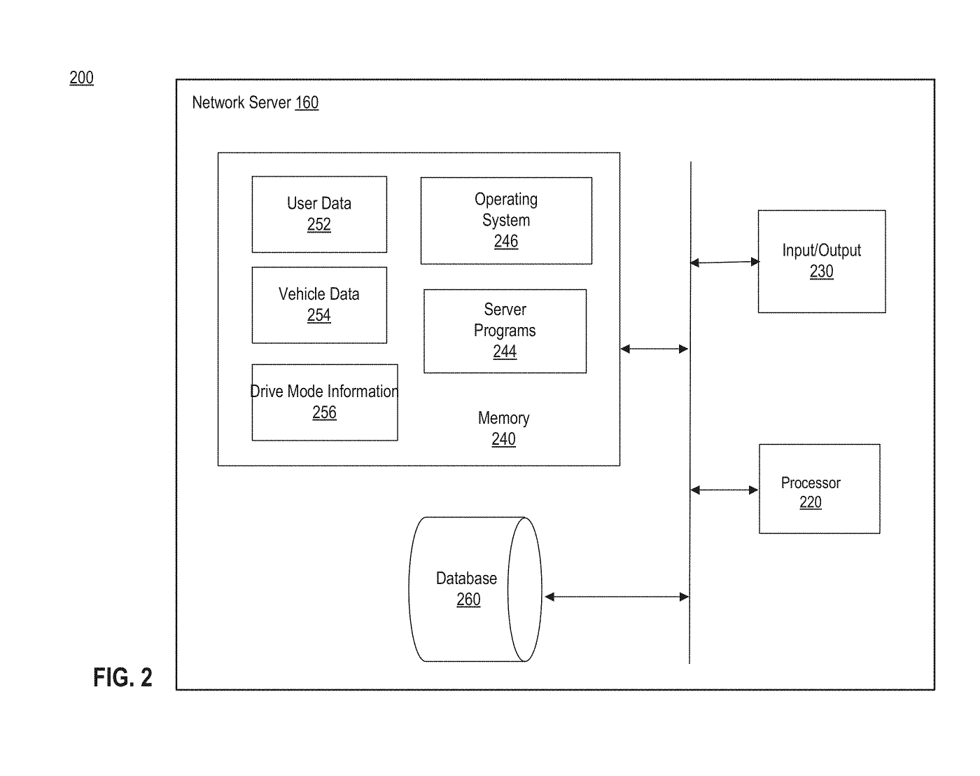

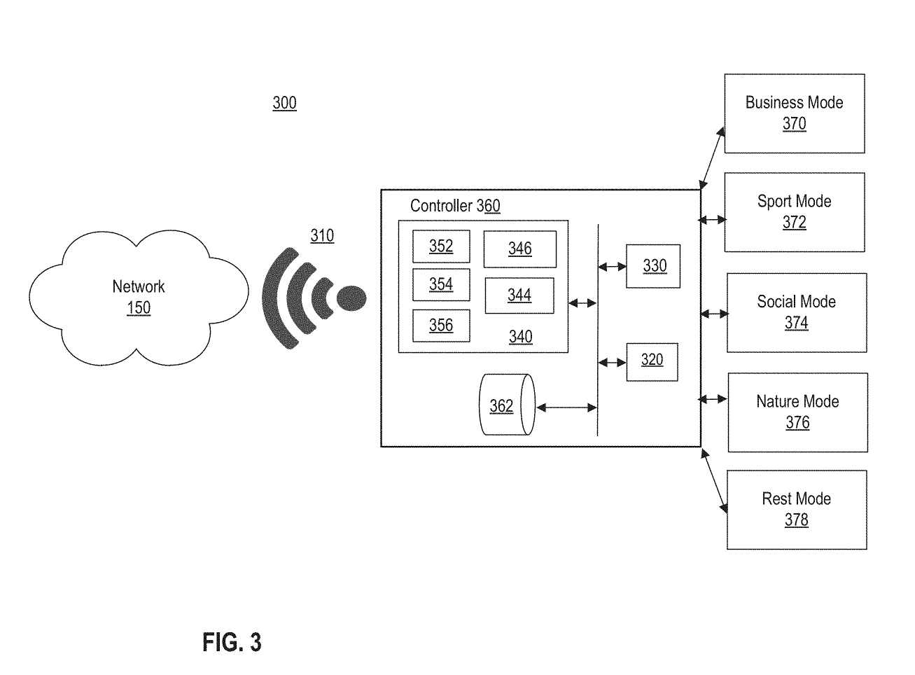

FIG. 2 is a schematic block diagram illustrating an exemplary network server 160, used in the exemplary system 100 of FIG. 1. It is contemplated that one or more personal devices 120 may include similar structures described in connection with network server 160. As shown in FIG. 2, network server 160 may include, among other things, a processor 220, personal/output (I/O) devices 230, memory 240, and a database 260, each coupled to one or more interconnected internal buses (not shown). Memory 240 may store among other things, server programs 244 and an operating system 246. Server programs 244 may be executed by cloud-based architecture or, alternatively, by a separate software program, such as a drive mode application (as further described with reference to FIGS. 4-9) for execution on personal device 120 and/or vehicle 130. Software program 244 may be located in personal devices 120, or in alternative embodiments, in a vehicle controller (as described with reference to FIG. 3) of vehicle 130. Software program 244 may configure remote control and update of vehicle settings and/or features according to user data, vehicle data, and drive mode information.

Memory 240 and/or database 260 may store user data 252 based on individual and/or aggregate user behavior. User data 252 may be input directly by a user into a drive mode application that is executed on a personal device 120 and/or vehicle 130. Alternately, user data may be detected by one or more sensors (e.g., imaging sensors and/or positioning sensors). Memory 240 may also store other data and programs. User data 252 may include user profiles, affiliated user login and/or other registration identification (ID) or user credentials, authentication timestamp information, network node or access point location(s) and/or preferences, and other metadata generated by algorithms in server programs 244. Memory 240 and/or database 260 may also store vehicle data 254 and drive mode information 256. Vehicle data 254 and drive mode information 256 may be directly input to a drive mode application that is executed on a personal device 120 and/or vehicle 130. Alternatively, vehicle data 254 and drive mode information 256 may be detected based on one or more sensors.

Database 260 may include Microsoft SQL databases, SharePoint databases, Oracle™ databases, Sybase™ databases, or other relational databases. Memory 240 and database 260 may be implemented using any volatile or non-volatile memory including, for example, magnetic, semiconductor, tape, optical, removable, non-removable, or any other types of storage devices or computer-readable mediums.

I/O interfaces 230 may include not only network interface devices, but also user interface devices, such as one or more keyboards, mouse devices, and GUIs executed on personal devices 120 and/or vehicle 130. For example, GUIs may include a touch screen where a user may use his fingers to provide input, or a screen that can detect the operation of a stylus. Network server 160 may provide user data 252, vehicle data 254, and drive mode information 256 for use in a drive mode application (as further described with reference to FIGS. 4-9) that is displayed and executed on personal device 120 and/or vehicle 130. Based on user input or user interaction with the GUI, personal device 120 and/or vehicle 130 may transmit user data 252, vehicle data 254, and drive mode information 256 to network server 160, from network 150 through I/O device 230, and may analyze such data to control and/or restrict vehicle 130 features and/or settings by modifying and/or configuring drive modes. Network server 160 may store a copy of user data 252, vehicle data 254, and drive mode information 256, for example, in memory 240, database 260, or in any other database accessible to server 160.

FIG. 3 is a schematic block diagram illustrating an exemplary vehicle controller 130, used in the exemplary system of FIG. 1. As illustrated in FIG. 3, vehicle 130 may include vehicle controller 360 capable of communicating with a transceiver 310, network 150, cloud platform 190, and personal device 120. Transceiver 310 may be capable of receiving one or more drive mode instructions (further described with reference to FIGS. 4-9) from one or more personal devices 120 and/or cloud platform 190 over network 150. Transceiver 310 may be capable of transmitting user data 352 from vehicle 130 to one or more personal devices 120 and/or cloud platform 190 over network 150. Controller 360 may transmit user data 352, vehicle data 354, and drive mode information 356. This information may be stored in memory 340 and/or database 362. Controller 360 may include one or more processors 320, input/output 330, controller programs 344 and operating system 346. Controller 360 may function in a manner similar to network server 160 and may operate independently or cooperatively with network server 160. Controller 360 may be configured to receive drive mode instructions to control, send, and/or edit drive mode features and/or settings. Features and/or settings may include braking, torque, suspension, speaker volume, and light brightness. Other features and/or settings are contemplated. A plurality of features and/or settings may be associated with a single drive mode or a plurality of drive modes. A user may modify drive modes according to requests from one or more registered users executing a drive mode application on personal device 120 and/or vehicle 130.

A selected drive mode may include a plurality of vehicle feature settings, such as vehicle exterior settings, interior settings, and drive settings. Depending on the vehicle feature settings, a drive mode may be characterized as a business mode 370, sport mode 372, social mode 374, nature mode 376, or rest mode 378. For example, business mode 370 may include a display of productivity applications, optimized suspension, brightened interior lights, tinted windows, and muted music. Sport mode 372 may include a tightened suspension, performance tracking and navigation, and tightened seat bolsters to conform to passengers. Social mode 374 may include a display of media-sharing applications, distribution of audible music to each passenger, and suspension optimized for smooth driving. Nature mode 376 may include a turned-off display, window tint reduction, and opened window. Rest mode 378 may include a dimmed display, calm music, tinted windows, and reclined seats. Other UI/UX originated drive modes and associated features are contemplated.

FIG. 4 is a diagrammatic illustration of multiple exemplary graphical user interfaces (GUIs) 400 used to configure drive modes. GUIs 400 may be displayed as part of a screen on personal device 120 and/or on vehicle 130. Exemplary GUIs 400 include a drive mode home screen 402, a customization screen 404, a “save” pop-up or dialogue box 406, and an electronic key screen 408. In the illustration, home screen 402 includes touch screen buttons including for existing drive modes such as “John,” “Jane,” “eco,” “sport,” and “comfort.” A user may select an existing drive mode and vehicle 130 may be configured accordingly. For example, Jane and her associated user profile may be detected when she enters a vehicle as a passenger or a driver, and an existing drive mode “Jane” may be retrieved and a screen button “Jane” may be displayed on home screen 402. Other generic drive modes not associated with any particular occupant, such as an “eco” mode or a “sport” mode may also be displayed for selection. Other combinations of drive modes may be displayed.

Home screen may also allow the user to “customize” a drive mode, i.e., creating a new one for his/her own. For example, Julie enters vehicle 130 and there may be no existing drive mode associated with Julie. Julie may press on “customize,” and proceed to customization screen 404 to create a “Julie” drive mode. In the illustration, customization screen 404 may allow for a user to toggle drive mode characteristics. For example, a user may adjust “regenerative braking,” “torque,” “suspension,” “speaker volume,” and “light brightness.” A user may then select touch buttons “Save” or “Share” to save or share the updated drive mode settings with other users. For example, Julie can configure a new drive mode and save it as “Julie” mode. Other users, such as John and Jane, may receive an alert or message sent to one or more personal devices 120 and/or in vehicle 130 when “Julie” mode is created. Other users, such as John and Jane, may also be able to access and implement “Julie” mode settings on one or more personal devices 120 and/or in vehicle 130. When a user selects “Save,” a pop-up or dialogue box 406 may show up that requests the user to confirm he/she intends to save the new drive mode. Upon confirming and selecting “Save” in pop-up or dialogue box 406, a message may then be sent to John and Jane alerting them that the new drive mode is created. Upon selecting “Share” in customization screen 404, the customized drive mode, e.g., “Julie” mode, may be shared with other users. For example, the user may be able to designate selected users, such as John and Jane, who can share the drive mode and use its feature settings. A notification may be sent to the designated users sharing the drive mode.

Once “saved,” the new drive mode may be displayed on home screen 402. For example, the “Julie” mode may be displayed on home screen 402 after it is created through screen 404 and saved through screen 408. In some embodiments, a user may also edit or update an existing drive mode by selecting the drive mode from home screen 402. For example, the user can select the “Julie” mode from home screen 402 to open customization screen 404 and make further edits on screen 404. After the updates are made, the user can save the updates through screen 406.

The drive mode may also be automatically synchronized to an electronic key associated with the user, and displayed on electronic key screen 408. As illustrated, electronic key screen 408 may display various existing drive modes, such as an “eco” mode, a “sport” mode, and the newly created “Julie” mode. Electronic key screen 408 may also display other settings related to the electronic key, such as speed limit and geofence. These settings specify the limits or restrictions to one or more authorized users while operating vehicle 130. A user may select an existing drive mode from the electronic key as well. Other graphical user interfaces, screen selections, and electronic key synchronizations may be contemplated.

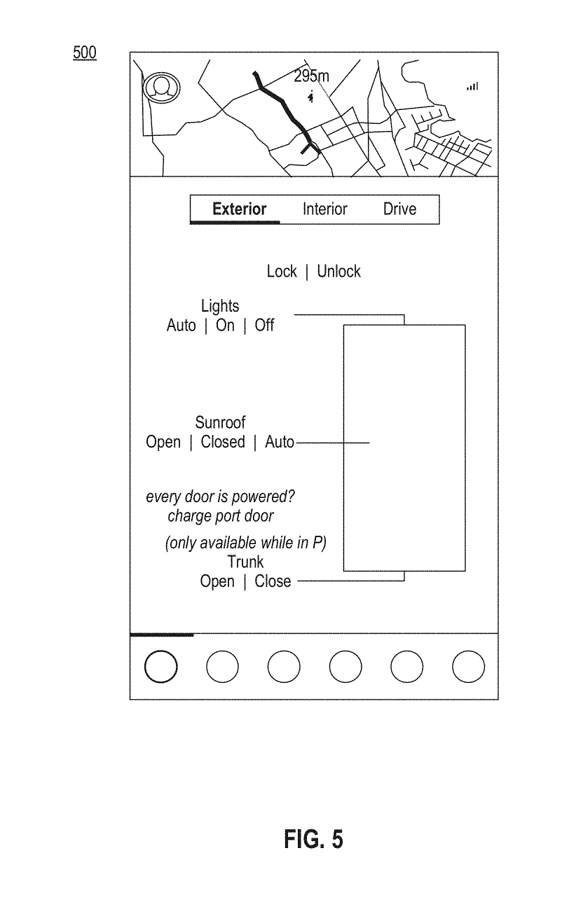

FIG. 5 is a diagrammatic illustration of an exemplary graphical user interface (GUI) 500 used to configure vehicle exterior settings. In the illustration, settings may be configured for the “Exterior,” “Interior,” or “Drive” components of vehicle 130. In the illustration, a user has selected “Exterior,” and accordingly, “Lock,” “Unlock,” “Lights,” “Sunroof,” and “Trunk” options are displayed for the user's selection. “Lights” may be configured to “Auto,” “On,” and “Off” “Sunroof” may be configured to “Open,” “Closed,” and “Auto.” “Trunk” may be configured to “Open” and “Close.” Also, other “Exterior” options may be configured. For example, “every door is powered?” and “charge port door,” as illustrated in FIG. 5, indicate “Exterior” power door settings. Other GUI screens for configuring “Exterior” settings may also be contemplated.

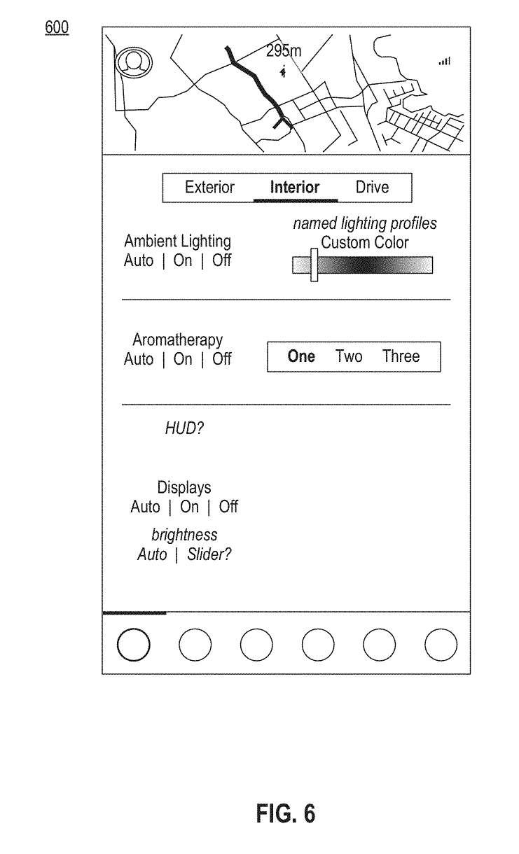

FIG. 6 is a diagrammatic illustration of an exemplary GUI 600 used to configure vehicle interior settings. In the illustration, settings may be configured for the “Exterior,” “Interior,” or “Drive” components of vehicle 130. In the illustration, a user has selected “Interior,” and accordingly, “Ambient Lighting,” “Aromatherapy,” and “HUD” may be displayed for user configuration. “Ambient Lighting” and “Aromatherapy” may each be configured according to “Auto,” “On,” and “Off” Custom color lighting profiles may be included and, three or more levels of aromatherapy may be included. “HUD” may be configured to adjust “Display” and “brightness.” Other GUI screens for configuring “Interior” settings may be contemplated.

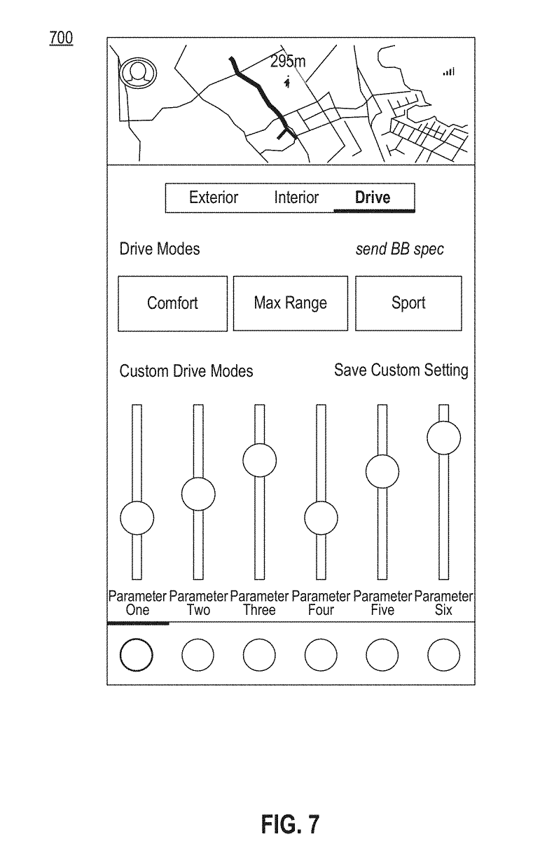

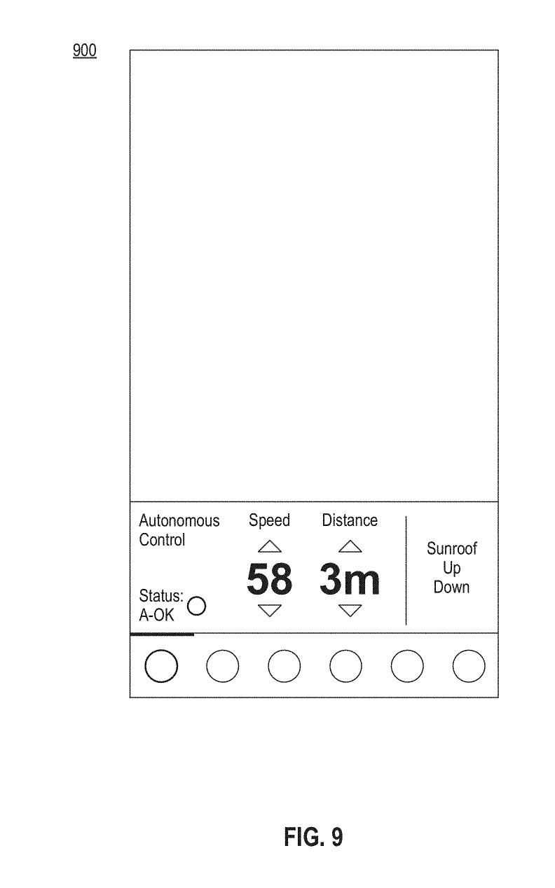

FIG. 7 is a diagrammatic illustration of an exemplary GUI 700 used to configure vehicle drive settings. In the illustration, a user has selected “Drive,” and accordingly, drive modes of “Comfort,” “Max Range,” and “sport” are displayed and may subsequently be selected. “Custom Drive Modes” and “Save Custom Setting” options are presented for configuration by a user. The user may be able to toggle one of six different parameters in order to customize the drive mode. For example, regenerative braking, torque, and suspension may be customized as three of the six parameters. The user may also be able to select “send BB spec” to input desired “bumper to bumper” distances associated with a corresponding drive modes executed under autonomous control (as further described with reference to FIG. 9). For example, in a “Comfort” mode, a preferred distance between the front bumper of vehicle 130 and a back bumper of another vehicle directly in front of vehicle 130 may be specified large so as to allow for comfortable, relaxed driving. Conversely, in a “sport” mode, a BB value may be specified small, indicative of an aggressive driving style corresponding to the “sport” mode. Other parameters may be included as part of the drive mode settings and may be contemplated.

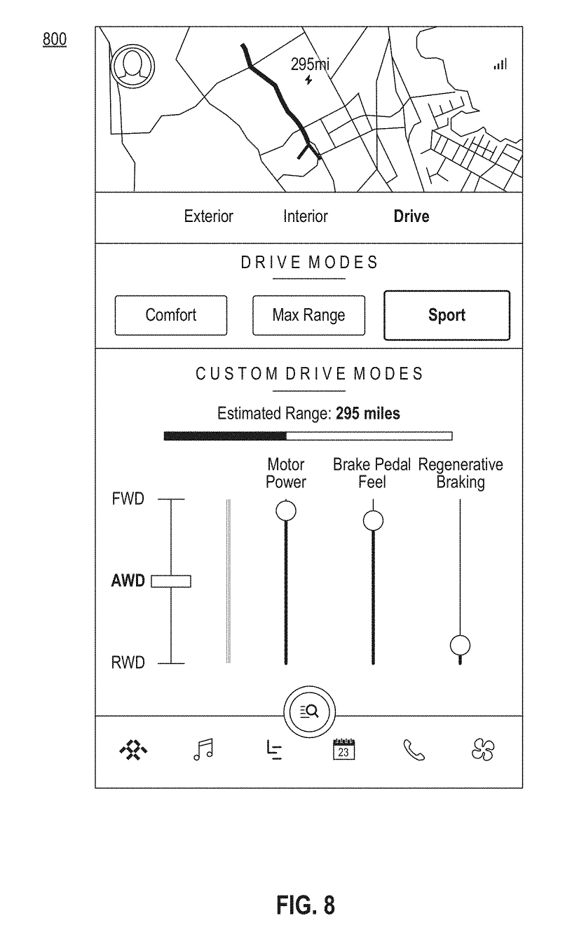

FIG. 8 is a diagrammatic illustration of an exemplary GUI 800 used to configure a sport mode 372. In the illustration, a user has selected “Drive,” and accordingly, drive modes of “Comfort,” “Max Range,” and “sport” are displayed and may subsequently be selected by a user operating a drive mode application on personal device 120 and/or vehicle 130. In the illustration, a user has selected “sport” settings, and accordingly, custom drive modes options pertaining to “sport” settings are displayed for user configuration. Specifically, Four Wheel Drive (“FWD”), All Wheel Drive (“AWD”), Rear Wheel Drive (“RWD”), “motor power,” “brake pedal feel,” and “regenerative braking” are displayed for configuration or adjustment. GUI 800 may provide slider bars, toggles, checkboxes, or other intuitive adjustment interfaces for the user to configure or adjust the parameters of respective settings. Similarly, based on user selection of custom drive mode options, an estimated drive range may also be calculated and displayed. Additionally, the labeling of a drive mode may or may not be reflective of corresponding drive mode options selected by a user. For example, although the drive mode, as illustrated, is labeled “sport,” its options may be customized so that the drive mode operates in normal fashion, or in other words, not in “sport” mode. Other GUIs for configuring the “Drive” settings may be contemplated.

FIG. 9 is a diagrammatic illustration of an exemplary GUI 900 used to configure an autonomous drive mode. In the illustration, a user may select “Autonomous Control,” which may include vehicle settings such as “Speed,” “Distance,” or climate and/or vehicle exterior conditions such as status of “Sunroof.” “Status: A-OK” is also displayed to a user. This status may be calculated based on one or more thresholds, and may indicate that vehicle 130 is being configured according to acceptable vehicle drive mode speeds and distances. GUI 900 may be used as a home screen or intermediate screen in combination with selected drive modes. Other GUI screens may be contemplated.

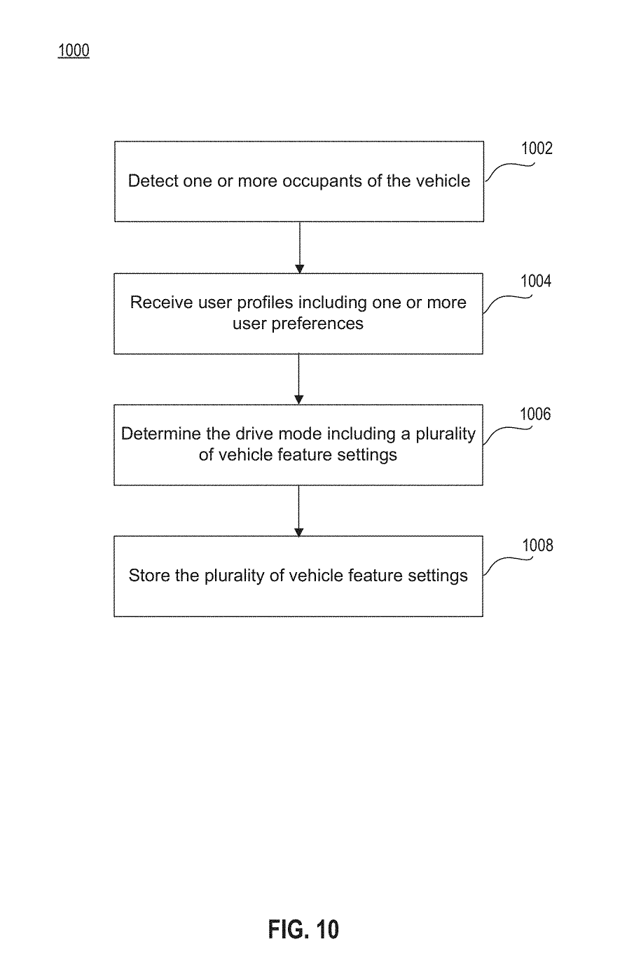

FIG. 10 is a flow chart illustrating an exemplary process 1000 that one or more processors may perform in accordance with the disclosed embodiments. While the exemplary process 1000 is described herein as a series of steps, it is to be understood that the order of the steps may vary in other implementations. In particular, steps may be performed in any order, or in parallel. One or more processors may include processors in personal device 120, network server 160, and/or processors in vehicle controller 360 of vehicle 130. In other words, each step of process 1000 may be performed by personal device 120, network server 160, vehicle controller 360, or their combinations.

At step 1002, process 1000 may include detecting one or more occupants in vehicle 130 according to sensor(s) 110 and processors 320. Sensor(s) 110 and processors 320 may be configured to detect one or more occupants based on identifying or determining user profiles and/or electronic keys of the driver and/or passenger. Sensor(s) 110 may include imaging sensors detecting vehicle occupants or positioning sensors configured to detect one or more user personal devices 120 held by occupants riding in vehicle 130. Other types of sensors may be contemplated. Processors 320 may compare the sensor detected information with existing user information to identify the occupants in vehicle 130.

At step 1004, process 1000 may include receiving user profiles including one or more user preferences. System 100 may allow for one or more personal devices 120 or vehicle 130 to receive user profiles associated with the detected occupants over network 150 from cloud platform 190. The received user profile may include, among other things, the user's identity information, biometric information, personal devices 120 and/or vehicles 130 associated with the user, and driving preferences of the user. In some embodiments, a preferred drive mode may be associated with each received user profile. The preferred drive mode may include user preferences on interior, exterior, and drive settings (described with reference to FIGS. 4-9). The one or more user preferences may be predetermined or stored within one or more received user profiles.

At step 1006, process 1000 may include determining the drive mode including a plurality of vehicle feature settings. In some embodiments, when there are multiple occupants in the vehicle, the drive mode may be determined based on the preferred drive mode settings indicated by the user profiles of the detected occupants in vehicle 130. In some embodiments, a weighting rule may be used to balance the preferences or preferred drive mode settings of the occupants when their preferences are different. For example, the one or more processors may assign a higher weight to the driver than to the passengers when determining a drive mode. As a result, certain drive mode settings preferred by the driver may be given more weight than drive mode settings preferred by the passengers, and subsequently will be applied to vehicle 130. The weighting rule may also be a majority rule where the preferences of a majority of occupants may determine certain drive mode settings. For instance, the preferences on “interior lighting” settings may be valued equally among a majority of vehicle occupants, and therefore, the “interior lighting” setting preferred by the majority of vehicle occupants may be adopted.

In some embodiments, the determined drive mode may be one of a business mode 370, sport mode 372, social mode 374, nature mode 376, or rest mode 378. Business mode 370 may include a display of productivity applications, optimized suspension, brightened interior lights, tinted windows, and muted music. Sport mode 372 may include a tightened suspension, performance tracking and navigation, and tightened seat bolsters to conform to passengers. Social mode 374 may include a display of media-sharing applications, distribution of audible music to each passenger, and suspension optimized for smooth driving. Nature mode 376 may include a turned-off display, window tint reduction, and opened window. Rest mode 378 may include a dimmed display, calm music, tinted windows, and reclined seats. Other modes, vehicle configurations, and feature settings may be contemplated. The plurality of feature settings may be dynamically adjusted based on the predetermined preferences of the occupants. One or more processors may be further configured to synchronize the drive mode to an electronic key associated with one or more detected occupants in vehicle 130, and the determined drive mode may be displayed on screen 408.

At step 1008, process 1000 may include storing the plurality of vehicle feature settings. In particular, controller 360 may store a copy of the user data 352, vehicle data 354, and drive mode information 356, for example, in memory 340, database 360, or in any other database accessible to server 160. Similarly, network server 160 may store user data 252, vehicle data 254, and drive mode information 256, and vehicle feature settings in memory 240 or database 260. Other storage means are contemplated.

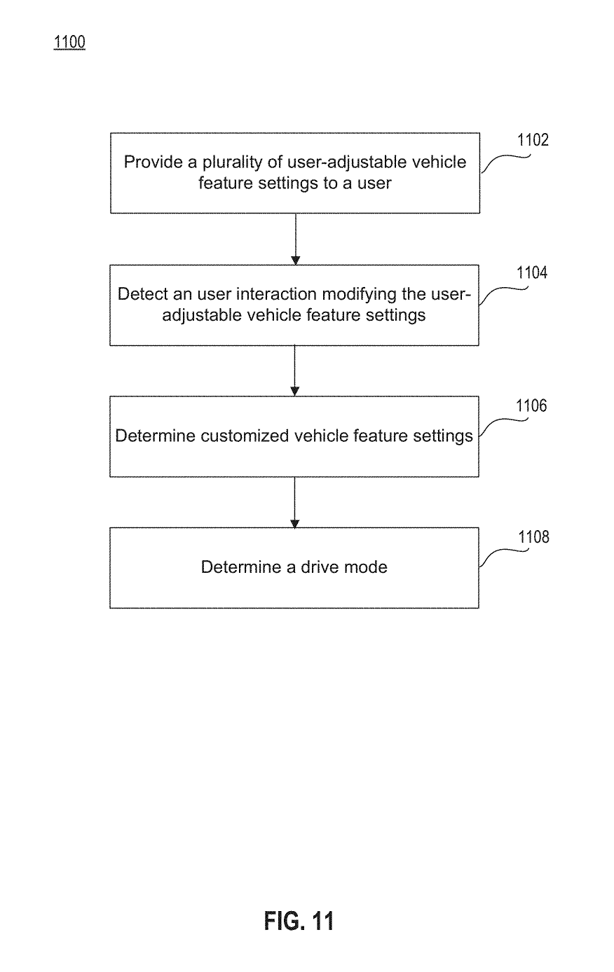

FIG. 11 is a flow chart illustrating another exemplary process 1100 that one or more processors may perform in accordance with the disclosed embodiments. While the exemplary process 1100 is described herein as a series of steps, it is to be understood that the order of the steps may vary in other implementations. In particular, steps may be performed in any order, or in parallel. One or more processors may include processors in personal devices 120, network server 160, and/or processors in vehicle controller 360 of vehicle 130. In other words, each step of process 1100 may be performed by personal device 120, network server 160, vehicle controller 360, or their combinations.

At step 1102, process 1100 may include providing a plurality of user-adjustable vehicle settings to a user. A GUI may be provided (as referenced with regard to FIGS. 4-9) to a user as part of a drive mode application executed on a personal device 120 and/or vehicle 130. In some embodiments, the plurality of user-adjustable vehicle feature settings may be provided as a slider, a checkbox, or a toggle. These settings may be set at a default level according to stored user data 352, vehicle data 354, and existing drive mode information 356. Settings may be turned on or off, and/or or modified based on one or more predetermined thresholds. Other means or configurations of providing settings to a user over a GUI are contemplated.

At step 1104, process 1100 may include detecting a user interaction modifying the user-adjustable vehicle feature settings. One or more processors in personal device 120 and/or vehicle 130 may detect a user configuring and/or updating drive mode features in a drive mode application executed on personal device 120 and/or vehicle 130. For example, the user may slide the slider, check the checkbox, or change the toggle. The user may perform the interaction with his fingers or using a stylus. Other detecting processes according to user interaction with drive mode GUIS (as referenced in FIGS. 4-9) are contemplated.

At step 1106, process 1100 may include determining customized vehicle feature settings. The plurality of user-adjustable vehicle feature settings may include suspension, torque, regenerative breaking, speaker volume, and light brightness settings. As described with reference to FIGS. 4-9, the customized feature settings may be manipulated, selected, toggled, and/or displayed. These feature settings may be stored in memory 340 for parsing and/or retrieving by the one or more processors. One or more processors may identify the changes to vehicle user settings based on a comparison with prior vehicle feature settings in order to determine customized vehicle feature settings. Other determination of user interactions is contemplated.

At step 1108, process 1100 may include determining a drive mode based on the customized vehicle feature settings. One or more processors may be further configured to associate the drive mode with a user profile of the user, and may synchronize the drive mode to an electronic key associated with the one or more occupants. For example, a “Julie” drive mode may be created and associated with Julie's user profile. The drive mode may be synchronized to an electronic key and displayed on the key screen. The drive mode may also be sent to or shared with a different user. For example, other users, including Julie's friends, e.g., John and Jane, may want to implement the “Julie” drive mode in their vehicle(s). Other users may request for the “Julie” drive mode and/or one or multiple of the associated vehicle feature settings. Alternatively, one or more users may be designated as recipients for the “Julie” drive mode. As described with reference to FIG. 4, a user may select “Save” or “Share” in customization screen 404 to store, send, and/or share drive mode and associated vehicle feature settings. A plurality of feature settings may also be dynamically set based on the preferences associated with user profiles. In addition to a “Julie” drive mode, a selected drive mode may include at least one of a business mode 370, sport mode 372, social mode 374, nature mode 376, or rest mode 378. Other modes, vehicle configurations, and feature settings inputted directly into GUI as part of a drive mode application executed on a personal device 120 and/or vehicle 130 may be contemplated.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for determining a drive mode for a vehicle, the system comprising:
one or more processors connected to a cloud network and configured to:
detect one or more occupants of the vehicle;
receive, from the cloud network, user profiles including one or more user preferences associated with the detected one or more occupants; and
determine the drive mode, including a plurality of vehicle feature settings, based on the user preferences weighted according to a weighting rule; and
a storage device configured to store the plurality of vehicle feature settings.

2. The system of claim 1, further comprising a sensor configured to detect features of the one or more occupants, wherein the one or more processors are further configured to identify a driver and at least one passenger among the one or more occupants based on the detected features and the user profiles.

3. The system of claim 2, wherein the weighting rule assigns a higher weight to the driver than to each of the at least one passenger.

4. The system of claim 1, wherein the weighting rule is a majority rule.

5. The system of claim 1, wherein the one or more processors are further configured to synchronize the drive mode to an electronic key associated with the one or more occupants.

6. The system of claim 1, wherein the drive mode includes at least one of a business mode, a sport mode, a social mode, a nature mode, or a rest mode.

7. A system for determining a drive mode for a vehicle, the system comprising:
a graphic user interface (GUI) configured to:
provide a plurality of user-adjustable vehicle feature settings to a user; and
detect a user interaction modifying the user-adjustable vehicle feature settings; and
one or more processors connected to the GUI and configured to:
determine customized vehicle feature settings based on the user interaction; and
determine a drive mode based on the customized vehicle feature settings.

8. The system of claim 7, wherein the one or more processors are further configured to associate the drive mode with a user profile of the user, and store the user profile in a cloud network.

9. The system of claim 7, wherein the GUI is further configured to detect a user interaction sharing the determined drive mode with one or more designated users, and wherein the one or more processors are further configured to provide the determined drive mode with the one or more designated users.

10. The system of claim 7, wherein the plurality of user-adjustable vehicle feature settings are provided as a slider, a checkbox, or a toggle.

11. The system of claim 7, wherein the plurality of user-adjustable vehicle feature settings include at least one of a suspension, a torque, or a regenerative breaking.

12. The system of claim 7, wherein the one or more processors are further configured to synchronize the drive mode to an electronic key associated with the user.

13. A method for determining a drive mode for a vehicle, comprising:
detecting one or more occupants of the vehicle;
receiving, from a cloud network, user profiles including one or more user preferences associated with the detected one or more occupants;
determining the drive mode, including a plurality of vehicle feature settings, based on the user preferences weighted according to a weighting rule; and
storing the plurality of vehicle feature settings.

14. The method of claim 13, further comprising:
detecting, by a sensor, features of the one or more occupants; and
identifying a driver and at least one passenger among the one or more occupants based on the detected features and the user profiles.

15. The method of claim 14, wherein the weighting rule assigns a higher weight to the driver than to each of the at least one passenger.
